(19) United States
(12) Patent Application Publication
(10) Pub. No.: US 2015/0378992 A1
(43) Pub. Date: Dec. 31, 2015

(54) METHOD AND APPARATUS FOR MOVING DATA IN DATABASE MANAGEMENT SYSTEM

(71) Applicant: Altibase Corp., Seoul (KR)

(72) Inventor: Jae Nam Choi, Seoul (KR)

(21) Appl. No.: 14/520,903

(22) Filed: Oct. 22, 2014

(30) Foreign Application Priority Data
Jun. 26, 2014 (KR) 10-2014-0079114

(51) Int. Cl. G06F 17/30

(52) U.S. Cl. CPC G06F 17/303; G06F 17/30486

(57) ABSTRACT

Provided are a method of moving data from a memory to a disk by using a single structural query language (SQL) statement and a method of moving data between tables.

### RELATED APPLICATION

This application claims the benefit of Korean Patent Application No. 10-2014-0079114, filed on Jun. 26, 2014, in the Korean Intellectual Property Office, the disclosure of which is incorporated herein in its entirety by reference.

### BACKGROUND

1. Field

One or more embodiments of the present invention relate to a method of moving data between tables in a database.

2. Description of the Related Art

It is inconvenient to use several structural query language (SQL) statements to move data between tables. In addition, a source table is searched twice, and even at this time, data that is inserted may be inconsistent with data that is deleted. KR 2010-0080817 discloses a technique of controlling access of database.

### SUMMARY

One or more embodiments of the present invention include a method of moving data from a memory to a disk. In addition, one or more embodiments of the present invention include a method of moving data between tables.

Additional aspects will be set forth in part in the description which follows and, in part, will be apparent from the description, or may be learned by practice of the presented embodiments.

According to one or more embodiments of the present invention, there is provided a database that implements a method of moving data from a memory to a disk. The method, which is performed by a computer and uses a single structural query language (SQL) statement, includes: searching for and reading a record that satisfies a certain condition in the memory; when the record that satisfies the certain condition is read, generating a destination record by using data within a column list in which the record read in the memory is comprised; and receiving a new page from the disk and inserting the destination record into the new page, wherein the searching for and reading, the generating, and the receiving and inserting are repeatedly performed in the database until the record that satisfies the certain condition is no longer found in the memory in the searching for and reading, and if the record that satisfies the certain condition is no longer found, all records that are searched for in the memory and satisfy the certain condition are deleted.

According to one or more embodiments of the present invention, there is provided a method, performed by a computer, of moving data in a certain partition by performing a single operation in a database, the method including: searching for a record that satisfies a condition in a source partition; generating a destination record by using data in a column list of the source partition where the record is searched for; and inserting the generated destination record into a new page by receiving the new page from a destination partition; wherein the searching for, the generating, and the inserting are sequentially and repeatedly performed, and if the record that satisfies the condition is no longer found in the searching for, all the records, which are searched for while the searching for, the generating, and the inserting are sequentially and repeatedly performed, are deleted.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 3 are diagrams for describing conventional methods of moving data between tables in a database;

FIG. 4 is a flowchart of a method of moving data from a memory of a database to a disk, according to an embodiment of the present invention;

FIGS. 5 to 6 are diagrams for describing moving data between tables, according to embodiments of the present invention;

FIGS. 7 to 11 show functions of structural query language (SQL) statements used to move data between tables in a database, according to embodiments of the present invention;

FIG. 12 is a flowchart of a method of moving data between tables, according to an embodiment of the present invention;

FIG. 13 shows a database for implementing a method of moving data between a memory and a disk, according to an embodiment of the present invention; and

FIG. 14 shows a database system for moving data between a memory and a disk, according to an embodiment of the present invention.

### DETAILED DESCRIPTION

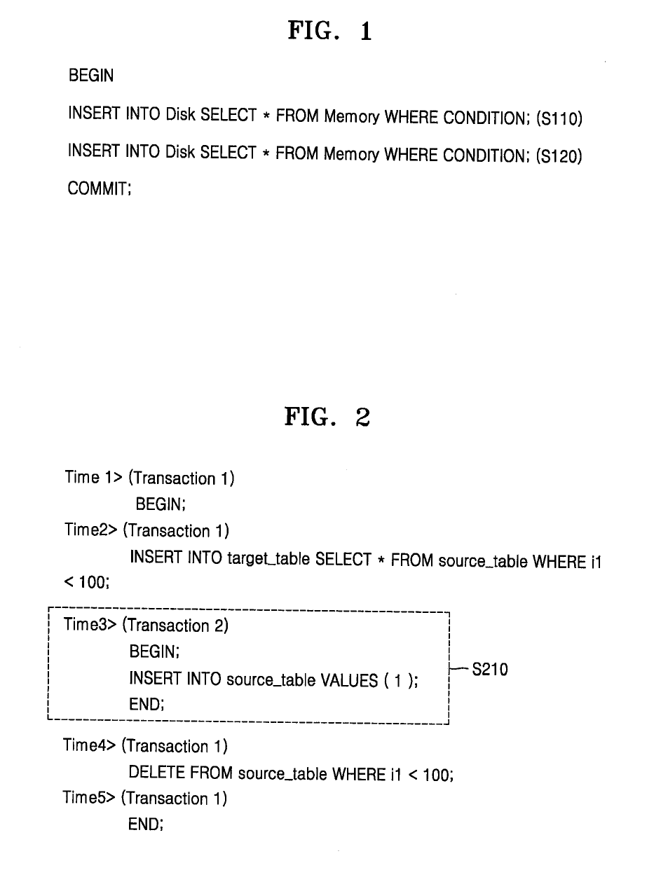

FIGS. 1 to 3 are diagrams for describing conventional methods of moving data between tables in a database.

FIG. 1 shows a conventional query used to move the data between the tables in a database management system (DBMS). The query has two problems: a performance-related problem which requires two searches for inserting the data (S110) and deleting the inserted data (S120); and user inconvenience.

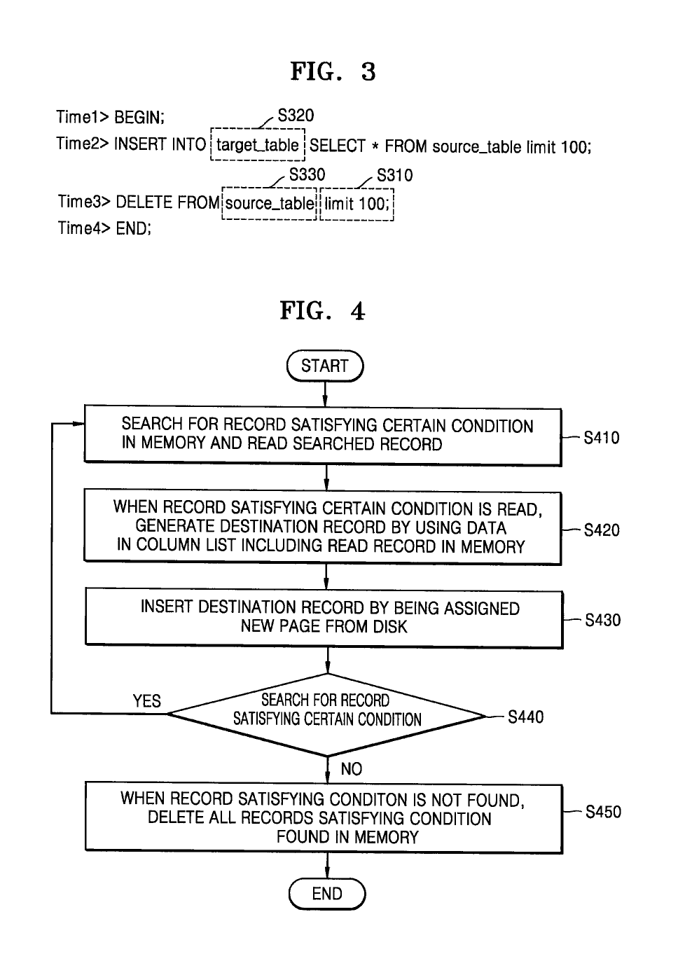

Also, data are inconsistent as shown in FIGS. 2 and 3.

FIG. 2 shows an example in which several SQL statements are used to move data between tables in a conventional DBMS and thus input data is inconsistent with deleted data in the conventional DBMS. When data is moved by executing SQL statements shown in FIG. 2, an input record may be deleted by Transaction 2 (S210).

As shown in FIG. 3, since several SQL statements are used to move data between tables in a conventional DBMS, the data may not be accurately moved.

In a LIMIT statement (S310) shown in FIG. 3, due to characteristics of the LIMIT statement, it is not guaranteed that identical content may be output whenever the data is moved. As a result, it is not guaranteed that 100 records, which are the same as those inserted into a target_table (S320), are deleted from a source table (S330). Thus, the data may not be accurately moved.

FIG. 4 is a flowchart of a method of moving data from a memory of a database to a disk, according to an embodiment of the present invention. The method may also be used when the data is moved between tables in the database.

Each operation described in FIG. 4 is executed by a computer and is implemented by a single SQL statement.
A first SQL statement example

MOVE INTO destination table (column_list) FROM source table (column_list) WHERE condition
A second SQL statement example

MOVE INTO Disk FROM Memory WHERE condition

In the first SQL statement example, “column_list” indicated in “destination table (column_list)” is a list of columns included in a destination table. “column_list” indicated in “source table (column_list)” is a list of columns included in a source table and may include a list of expressions. In this case, the expressions may include at least one of four fundamental arithmetic operations, host variables, sub-queries, conversion functions, and constants.

Referring to the second SQL statement example, a record satisfying a certain condition is searched for and read in a memory in operation S410. When a record, which satisfies a “condition” indicated after the WHERE statement, is read, a destination record is generated by using data in a column list in which the record read in the memory is included, in operation S420.

Then, a new page is assigned by a disk, and the generated destination record is inserted into the new page, in operation S430.

Operations S410 through S430 are repeatedly performed until it is determined that the record that satisfies the certain condition is no longer found in the memory in operation S440.

If the record that satisfies the “condition” indicated after the WHERE statement is no longer found, all records found in the memory and satisfying the “condition” indicated after the WHERE statement are deleted, in operation S450.

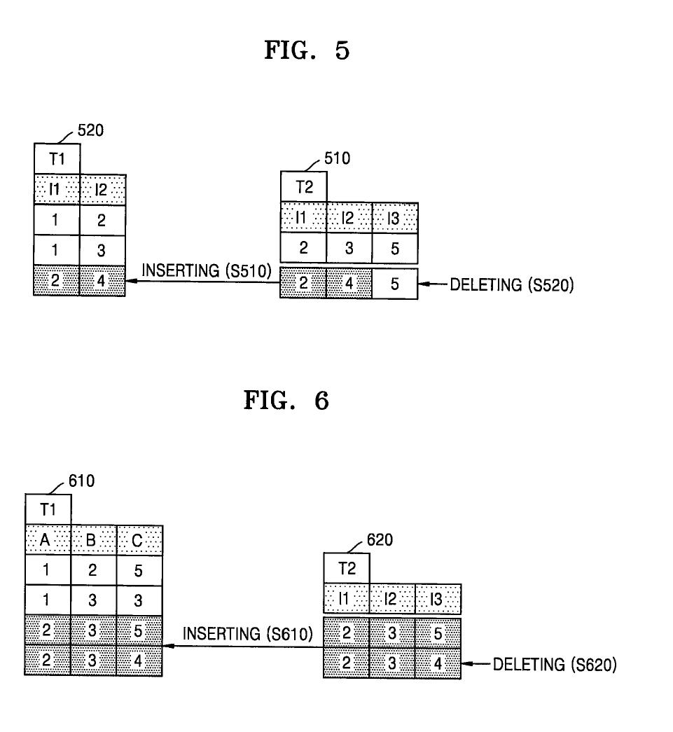

FIGS. 5 to 6 are diagrams for describing moving data between tables, according to embodiments of the present invention.

FIG. 5 shows an example in which rows satisfying a condition of T2.I2=4 are moved from a second table 510 to a first table 520 and are deleted from the second table 510, in operation S510.

In a database, each column values of I1 and I2 of the rows the second table 510, which satisfy the condition of T2.I2=4, are inserted into rows of two columns I1 and I2 of the first table 520 in operation S510, and then are deleted from the second table 510, in operation S520.

FIG. 6 shows an example in each column values of rows of a second table 620 are inserted into a first table 610 in operation S610, and then are deleted from the second table 620 in operation S620. In this case, the first table 610 needs to have the same number of columns corresponding to those of the columns I1, I2, and I3 of the second table 620.

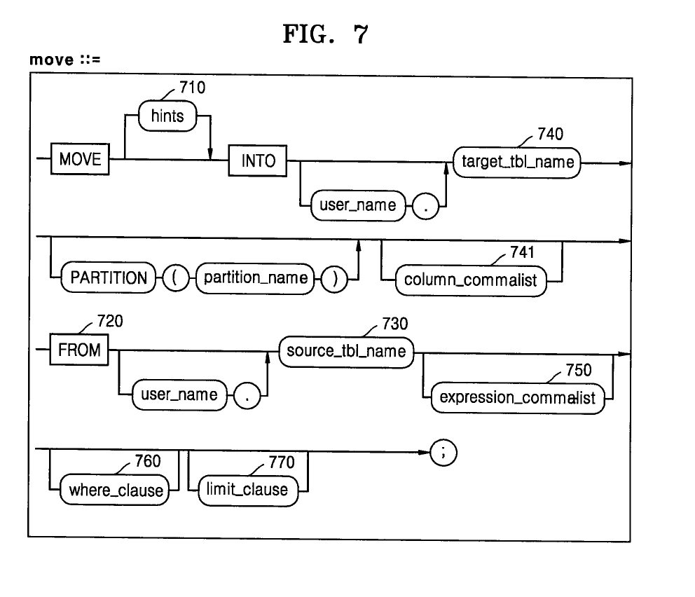

FIGS. 7 to 11 show a data manipulation language (DML) structure forming the single SQL statement described with reference to the first and second SQL statement examples, according to embodiments of the present invention.

Hints 710 are hints regarding a FROM clause 720 and are the same as hints used in a SELECT statement.

A source_tbl_name 730 and a target_tbl_name 740 respectively denote a source table and a destination table with regard to movement of data.

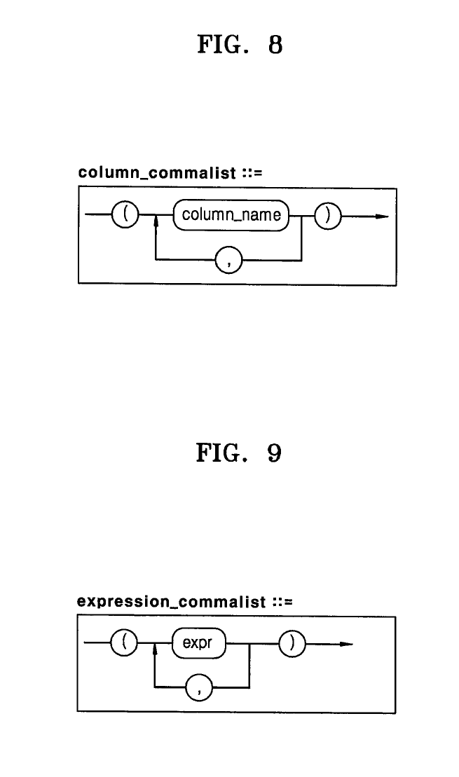

A column_commalist 741 of FIGS. 7 and 8 shows a list of actual columns included in the destination table 740.

An expression_commalist 750 of FIGS. 7 and 9 is a list of expressions identified by commas. Each of the expressions may be a column, a constant, or an expression included in a FROM table.

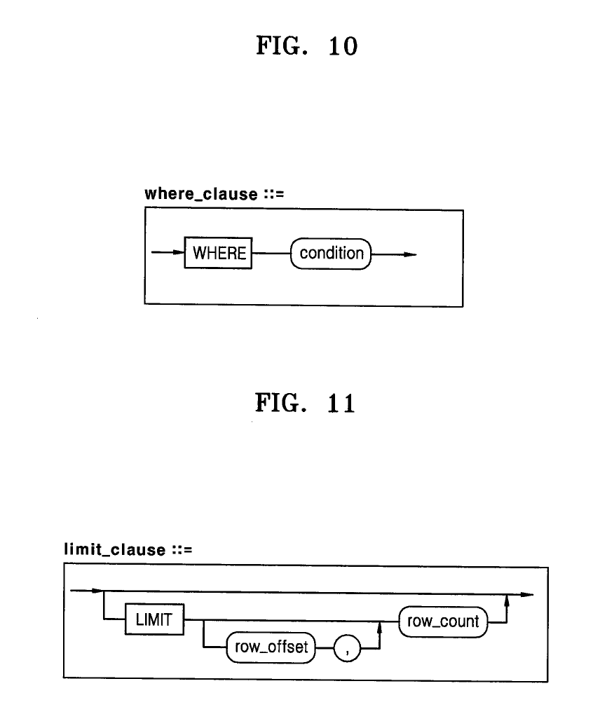

A where_clause 760 of FIGS. 7 and 10 has the same structure as a WHERE clause of the SELECT statement.

A limit_clause 770 of FIGS. 7 and 11 has the same structure as a LIMIT clause of the SELECT statement.

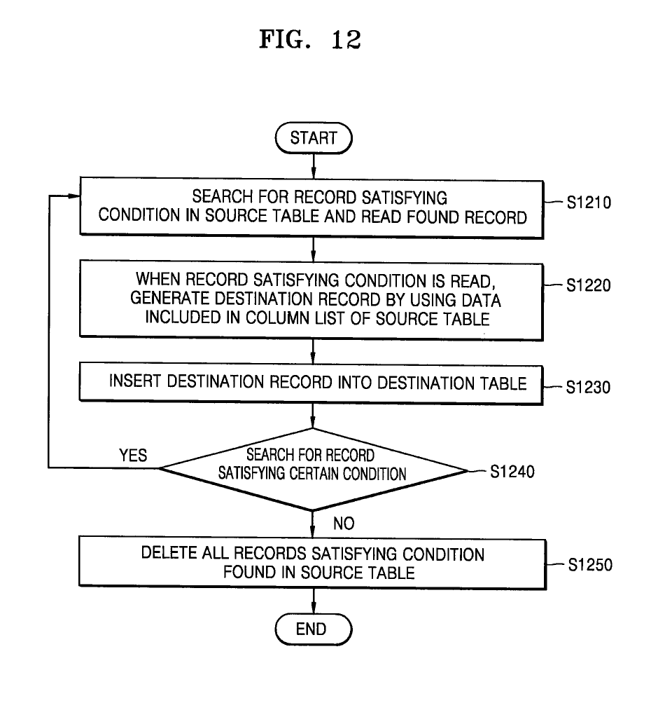

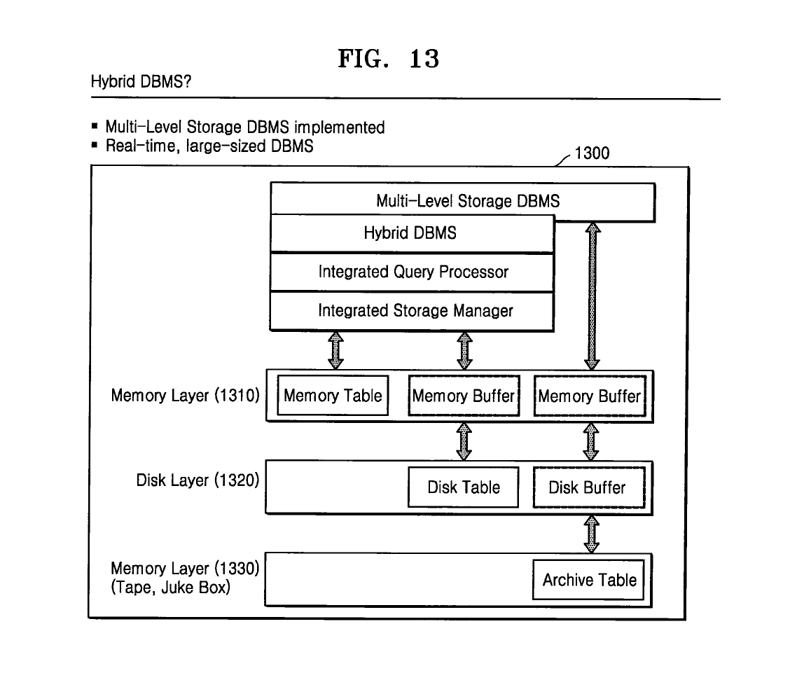

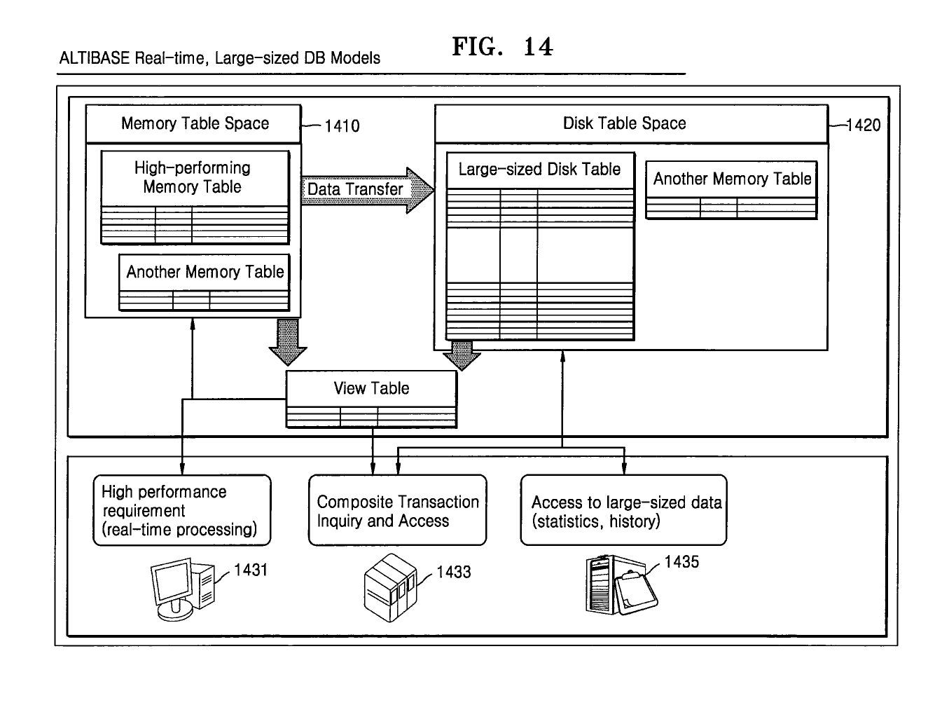

FIG. 12 is a flowchart of a method of moving data from a source table to a destination table, according to an embodiment of the present invention. The method is performed by using the single SQL statement described with reference to the first SQL statement example and includes the following operations executed by a computer.

In the source table of a database, a record that satisfies a condition is searched for and read, in operation S1210. When the record that satisfies the condition is read, a destination record is generated by using data within a column list of the source table, which is to be moved, in operation S1220.

The destination record is inserted into the destination table in operation S1230. Then, in operation S1240, operation S1210, operation S1220, and operation S1230 are repeatedly performed in the database until it is determined that the record that satisfies the condition is no longer found in the source table in operation S1210.

If the record that satisfies the condition is no longer found, all records that satisfy the condition and are found in the source table are deleted, in operation S1250.

As described above, according to the one or more of the above embodiments of the present invention, data may be moved between tables by using a single SQL statement, and since the data may be moved between tables after searching a source table only once, search costs may be reduced.

Also, when the data is moved between tables, moving data input into a table may be inconsistent with data deleted from the table. However, one or more embodiments of the present invention include solutions to the above-described problem, and thus, the data may be accurately moved.

The invention can also be embodied as computer readable codes on a computer readable recording medium. The computer readable recording medium is any data storage device that can store programs or data which can be thereafter read by a computer system.

Examples of the computer readable recording medium include read-only memory (ROM), random-access memory (RAM), CD-ROMs, magnetic tapes, hard disks, floppy disks, flash memory, optical data storage devices, and so on. The computer readable recording medium can also be distributed over network coupled computer systems so that the computer readable code is stored and executed in a distributive manner.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A database that implements a method of moving data from a memory to a disk, wherein the method, which is performed by a computer and uses a single structural query language (SQL) statement, comprises:
searching for and reading a record that satisfies a certain condition in the memory;
when the record that satisfies the certain condition is read, generating a destination record by using data within a column list in which the record read in the memory is comprised; and
receiving a new page from the disk and inserting the destination record into the new page,
wherein the searching for and reading, the generating, and the receiving and inserting are repeatedly performed in the database until the record that satisfies the certain condition is no longer found in the memory in the searching for and reading, and
if the record that satisfies the certain condition is no longer found, all records that are searched for in the memory and satisfy the certain condition are deleted.

2. A method, performed by a computer, of moving data from a source table to a destination table in a database, the method comprising:
searching for and reading a record that satisfies a condition in a source table;
when the record that satisfies the condition is read, generating a destination record by using data within a column list of the source table, which is to be moved; and
inserting the destination record into a destination table,
wherein the searching for reading, the generating, and the inserting are repeatedly performed until the record that satisfies the condition is no longer found in the source table in the searching for and reading, and
if the record that satisfies the condition is no longer found, all records that are searched for in the source table and satisfy the condition are deleted.

3. The method of claim 2, wherein the source table is different from the destination table.

4. The method of claim 2, wherein, in the inserting, a new page is received by the destination table, and the destination record is inserted into the new page of the destination table.

5. The method of claim 2, wherein the searching for and reading, the generating, and the inserting are performed by a single structural query language (SQL) statement that moves data from the source table to the destination table in the database.

6. The method of claim 5, wherein the single SQL statement is “MOVE INTO destination table (column_list) FROM source table (column list) WHERE condition”.

7. The method of claim 6, wherein the record that satisfies the condition is searched for and read in the source table, and when the record that satisfies the condition is read, the destination record is generated by using the data within the column list of the source table, which is to be moved, by using “FROM source table (column_list) WHERE condition” statement of the single SQL statement,
the record that is searched for is inserted into the destination table by using the “MOVE INTO destination table (column_list)” statement of the single SQL statement, and
if the record that satisfies a “WHERE condition” is no longer found, all records that were searched for and satisfy the condition in the source table are deleted.

8. The method of claim 6, wherein “column_list” indicated in the “source table (column_list)” is a list of columns comprised in the source table, and “column_list” indicated in the “destination table (column_list)” is a list of columns comprised in the destination table.

9. The method of claim 8, wherein the “column_list” indicated in the “source table (column_list)” is the list of columns comprised in the source table and comprises a list of expressions, and
the expressions comprise at least one of four fundamental arithmetic operations, host variables, sub-queries, conversion functions and constants.

10. A method, performed by a computer, of moving data in a certain partition by performing a single operation in a database, the method comprising:
searching for a record that satisfies a condition in a source partition;
generating a destination record by using data in a column list of the source partition where the record is searched for; and
inserting the generated destination record into a new page by receiving the new page from a destination partition;
wherein the searching for, the generating, and the inserting are sequentially and repeatedly performed, and
if the record that satisfies the condition is no longer found in the searching for, all the records, which are searched for while the searching for, the generating, and the inserting are sequentially and repeatedly performed, are deleted.

11. The method of claim 10, wherein the single operation comprises a single structural query language (SQL) statement that is “MOVE INTO destination partition (column_list) FROM source partition (column_list) WHERE condition”.
